(19) United States
(12) Patent Application Publication
(10) Pub. No.: US 2005/0215242 A1
(43) Pub. Date: Sep. 29, 2005

(54) Automatic mobile call forwarding with time-based trigger events

(75) Inventors: Kenneth R. Black, Lakeland, FL (US); Robert M. Jensen, Lakeland, FL (US); Craig D. Skiles, Largo, FL (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: Black Cypress, Inc., Lakeland, FL (US)

(21) Appl. No.: 10/899,957

(22) Filed: Jul. 27, 2004

Related U.S. Application Data
(60) Provisional application No. 60/557,133, filed on Mar. 26, 2004.

(51) Int. Cl. H04M 3/42

(52) U.S. Cl. 455/417; 455/414.1

(57) ABSTRACT

A method of forwarding calls directed to a cellular phone to a target phone number based on time-based trigger events. A call forward profile associated with the cellular phone is defined, wherein the profile has associated therewith a window of time for forwarding calls and the target phone number. The call forward profile is stored in memory in the cellular phone and the cellular phone periodically determines when it is within the window of time of a call forward profile. If so, the cellular phone notifies the cellular provider associated with cellular phone to forward later-received calls to the target number using the cellular provider's own activation and deactivation codes. Notification by the cellular phone to the cellular provider may be set to automatic or only after a prompt to the cellular phone user.

### CROSS REFERENCE TO RELATED APPLICATION

This application claims the benefit under 35 U.S.C. § 119(e) of U.S. provisional patent application No. 60/557,133, entitled “AUTOMATIC MOBILE CALL FORWARDING USING ACTIVE PROFILES AND TIME OR LOCATION BASED TRIGGER EVENTS,” filed Mar. 26, 2004, which is incorporated herein in its entirety by reference.

### FIELD OF THE PRESENT INVENTION

The present invention relates generally to the field of mobile wireless communication systems, and more specifically, to the field of wireless call forwarding systems.

### BACKGROUND OF THE PRESENT INVENTION

Many cellular communication service provider plans allow cellular subscribers to manually forward incoming telephone calls, directed initially to the subscriber's handset, to an alternate target telephone number. In some subscriber plans, for example, users forward calls by depressing a feature access code, such as “*72” or some other key sequence, entering a forwarding telephone number, and then depressing the “send” key. Several cellular communications service providers allow for several types of call forwarding features. For example, a typical “Forward All-Calls” feature will forward all incoming calls to the designated target phone number, while a “Forward No-Answer Busy” feature will forward incoming calls if the mobile telephone is already on a phone call or if an incoming call is not answered by the mobile telephone. One negative aspect of these manual systems is that there is no visual indication of the current call forwarding state of the mobile phone, and it is highly likely that the user will inadvertently miss phone calls because the user will forget to disable call forwarding.

Some cellular phone manufacturers have provided software programs in their phones to allow the user to configure these feature access code(s) manually, and save a telephone number to be used on subsequent call forwarding manual operations in order to minimize the keystrokes needed to activate and deactivate call forwarding. These call forwarding schemes provide users with only a single target phone number, which is to be used for all call forwarding actions, and the user must still manually activate or deactivate the call forwarding feature.

Several location-based call forwarding schemes and methods have been developed to provide call forwarding based on a mobile telephone's geographic location. For example, Alperovich et al. U.S. Pat. No. 5,978,673 entitled “Providing Location-Based Call Forwarding Within A Mobile Telecommunications Network” teaches a method of storing a plurality of forwarding numbers, each forwarding number correlated with a specific service area in a home location register (HRL) associated with a particular mobile station, and then forwarding calls to the forwarding number associated with the particular service area in which the mobile station is located. The storage, correlation, and forwarding of calls in Alperovich all occur on the network side of the communication system. In addition, such system only provides for location-based call forwarding.

Further, Carr U.S. Pat. No. 6,091,948 entitled “One Number Service Using Mobile Assisted Call Forwarding Facilities” teaches storing several forwarding numbers on the mobile telephone, each forwarding number correlated with a specific location, and providing automatic activation and deactivation of call forwarding upon power-up and power-down of the mobile telephone. A similar system is disclosed in Phillips U.S. Pat. App. No. 2002/0173297. In both of these systems, call-forwarding automation occurs only during the power-up and power-down sequence of the mobile telephone. Thus, such systems do not enable activation or de-activation of call forwarding when the phone is on and as the user moves from place to place. Correspondingly, such systems are only able to provide for location-based call forwarding automation, but not time-based automation.

Other known location-based call forwarding schemes are based on hardware-supported call forwarding. Special hardware, such as a landline residential base station in a dual mode cordless/cellular system, detects the presence of the mobile unit when within range of the special hardware (i.e., the mobile unit is at work or at home) or when the mobile unit is sitting within its charging base station. The special hardware then notifies the wireless telephone system to forward all calls to the preprogrammed land line telephone at that location. This solution requires an additional investment by the user in the special hardware, may also require system infrastructure modifications, and only works if the mobile unit is within range of or plugged into the special hardware.

Other known call forwarding schemes forward calls by modeling the subscriber's activity to predict where the subscriber is likely to be reached based upon past behavior. See, for example, Will U.S. Pat. No. 5,905,789 entitled “Call-Forwarding Scheme Using Adaptive Model of User Behavior.” The modeling in Will is performed on the network side of the communication system.

For these and many other reasons, there is a need for a system and method for a call forwarding automation feature in a wireless telephone that provides automated activation and deactivation of conventional cellular provider system call forwarding services utilizing multiple active user-defined profiles.

There is a further need for a wireless telephone that includes logic, a time source, a method for discovering the wireless telephone's geographic location, and memory for storing multiple call forwarding profiles which include target phone numbers and other configuration items, selecting a call forwarding profile based upon either or both a time or geographic location information, and automatically activating and deactivating call forwarding to the selected profile's target telephone number. There is a need for programming installed in the device that enables the user manually to activate and deactivate call forwarding utilizing a user-defined profile, that enables the user to add and configure new profiles, change parameters in existing profiles, and to configure and enable the call forwarding automation feature control settings, and to provide the user with audible and/or visual reminders of the current call forwarding state.

There is yet a further need for a wireless telephone that automatically prompts the user for activation or deactivation of call forwarding upon each trigger event. Such trigger event is usable to select an active call forwarding profile, but preferably the selected call forwarding profile is used only to provide a suggested change to the call forwarding state, rather than automatically activating or deactivating call forwarding without user input. There is a corresponding need for a system in which, if user input is not received during a defined period in response to the prompt, the wireless telephone automatically activates or deactivates call forwarding only if a call forwarding automation feature control setting time-out default option is enabled.

There is also a need for a system that includes all of the above functionality without the need for discovering the wireless telephone's geographic location, and thus having no location-based trigger events.

There is a need for such systems in which the call forwarding automation feature described above is preferably embedded in a mobile telephone by the equipment provider or, alternatively, added as an independently developed software application that is downloaded and installed upon the handset by the user.

It is therefore an object of the present invention to provide a wireless telephone feature which automatically enables a wireless telephone subscriber to be contacted at various locations and at various times by using a single telephone number.

Another object of the present invention is to provide a wireless telephone call forwarding activation and deactivation automation feature.

Another object of the present invention is to provide a wireless telephone call forwarding automatic activation and deactivation feature that requires a small number of keystrokes during use.

Another object of the present invention is to provide a wireless telephone call forwarding manual activation and deactivation feature that requires a minimum number of keystrokes during use.

Another object of the present invention is to provide a wireless telephone call forwarding activation and deactivation feature that provides the user with audible and/or visual reminders of the current call forwarding state to minimize accidental lost calls because the user forgot to disable call forwarding.

Another object of the present invention is to provide a wireless telephone call forwarding activation and deactivation feature that automatically interacts with a conventional call forwarding system of a cellular provider.

Another object of the present invention is to provide a wireless telephone call forwarding activation and deactivation feature that provides system-specific interaction with multiple conventional call forwarding systems of various cellular providers.

Another object of the present invention is to provide a wireless telephone call forwarding feature that intelligently selects a proper call forwarding telephone number based on time-based trigger events that occur within the wireless telephone based on the wireless telephone's knowledge of the current time.

Another object of the present invention is to provide a wireless telephone call forwarding feature that intelligently selects a proper call forwarding telephone number based on location-based trigger events that occur within the wireless telephone based on the wireless telephone's knowledge of its location.

The present invention meets one or more of the above-referenced needs or objects as described herein in greater detail. Other objects, features, and advantages of the present invention will also become apparent upon reading and understanding the present specification, when taken in conjunction with accompanying drawings and claims.

### SUMMARY OF THE PRESENT INVENTION

The present invention relates generally to the field of mobile wireless communication systems, and more specifically, to the field of wireless call forwarding systems. Briefly described, aspects of the present invention include the following.

In a first aspect of the present invention, a method of forwarding calls directed to a cellular phone to a target phone number, comprises the steps of defining a call forward profile associated with the cellular phone, the call forward profile defining a window of time for forwarding calls directed to the cellular phone, the call forward profile further identifying the target phone number associated therewith; storing the call forward profile in memory in the cellular phone; determining, by the cellular phone, that the cellular phone is currently within the window of time of the call forward profile; and notifying, by the cellular phone, a cellular provider associated with cellular phone to forward later-received calls to the target number.

A further feature of the first aspect of the invention includes the further step of notifying the cellular provider to deactivate call forwarding to the target phone number after expiration of the window of time. In some features, the cellular phone provides the cellular provider with the expiration of the window of time during the step of notifying the cellular provider to forward later-received calls. In other features, upon the expiration of the window of time, the cellular phone notifies the cellular provider to deactivate call forwarding to the target number.

In a further feature, the method further comprises the step of automatically notifying the cellular provider to forward calls directed to the cellular phone to a second target phone number after expiration of the window of time.

In other features, the cellular phone is associated with a user and the user is not required to know call forward service codes of the cellular provider.

In additional features, the step of notifying is performed automatically by the cellular phone without further input by a user of the cellular phone or is performed by the cellular phone after specific authorization is received from a user of the cellular phone.

In yet further features, the cellular phone provides a user-interface for the user to define the call forward profile and a call forward status indicator to a user of the cellular phone. The call forward status indicator may be displayed on a screen of the cellular phone or may be a sound, such as a beep, series of notes, or spoken words, generated by the cellular phone.

In other features, the call forward status indicator is generated upon the forwarding of each call to the target phone number or after notifying the cellular provider to forward calls to the target number or merely on a periodic basis.

In a second aspect of the present invention, a method of pre-programming a cellular telephone to forward calls to a target phone number, the cellular telephone being associated with a cellular provider, comprises defining a time-based trigger event for call forwarding purposes; associating the target phone number with the trigger event; storing the trigger event and the target phone number in memory in the cellular telephone; detecting, by the cellular telephone, the occurrence of the trigger event; and, upon detection of the trigger event, notifying by the cellular telephone the cellular provider to forward later-received calls to the target number.

In various features, the trigger event is a specific time of day, a recurring event, is based on a day of the week, or is a specific calendar day.

In other features, the trigger event has an expiration and the method further comprises the step of notifying the cellular provider to deactivate call forwarding to the target phone number upon the occurrence of the expiration or the step of automatically notifying the cellular provider to forward calls directed to the cell phone number to a second target phone number after the expiration.

In another feature, the cellular phone is associated with a user and the user is not required to know call forward service codes of the cellular provider.

In yet further features, the step of notifying is performed automatically by the cellular phone without further input by a user of the cellular phone or is performed by the cellular phone after prompting a user of the cellular phone and receiving authorization from the user.

In a different feature, the trigger event and the associated target phone number are part of a user-defined profile stored in memory in the cellular phone and, further, the cellular phone include software installed thereon to enable a user of the cellular phone to create the user-defined profile.

In another feature, the cellular phone provides a call forward status indicator to a user of the cellular phone, wherein the call forward status indicator is displayed on a screen of the cellular phone and/or wherein the call forward status indicator is a sound generated by the cellular phone. The sound may include a beep, series of notes, or spoken words.

Preferably, the call forward status indicator is generated upon the occurrence of the trigger event and/or upon the forwarding of each call to the target phone number.

In a third aspect of the present invention, a method of enabling activation and deactivation of call forwarding in a cellular phone, the cellular phone associated with a cellular provider, comprises the steps of enabling a user of the cellular phone to define a plurality of call forward profiles associated with the cellular phone, each call forward profile defining time-based activation and deactivation trigger events, each call forward profile having associated therewith a respective target phone number for call forwarding purposes; storing the plurality of call forward profiles in memory in the cellular phone; detecting the occurrence of a respective trigger event associated with one of the plurality of call forward profiles; and notifying, by the cellular phone, the cellular provider to activate or deactivate call forwarding to the respective target phone number as a function of the respective trigger event and the respective call forward profile.

In features of the third aspect of the present invention, the step of notifying is performed automatically by the cellular phone upon the occurrence of the respective trigger event without further input by the user or the step of notifying is performed by the cellular phone after the occurrence of the respective trigger event and after receiving specific authorization from the user of the cellular phone.

In various features, the trigger events are specific times of a day, are recurring events that occur on a plurality of days, are associated with one or more days of the week, are associated with a specific calendar date.

In other features, the user is not required to know call forward service codes of the cellular provider and the cellular phone include software installed thereon to enable the user to define the call forward profiles.

In another feature, the cellular phone provides a call forward status indicator to a user of the cellular phone, wherein the call forward status indicator is displayed on a screen of the cellular phone and/or wherein the call forward status indicator is a sound generated by the cellular phone. The sound may include a beep, series of notes, or spoken words.

Preferably, the call forward status indicator is generated upon the occurrence of the trigger event and/or upon the forwarding of each call to the respective target phone number.

In a fourth aspect of the present invention, a cellular phone associated with a cellular provider and having software installed thereon that is configured to perform the steps of providing a user-interface to a user of the cellular phone to define a call forward profile, the call forward profile defining time-based trigger events for activating and deactivating call forwarding associated with the cellular phone, the call forward profile identifying a target phone number associated therewith; storing the call forward profile in memory in the cellular phone; thereafter, determining the occurrence of one of the time-based trigger events for activating call forwarding; and notifying the cellular provider to forward subsequent calls intended for the cellular phone to the target phone number.

In various features, the trigger events are specific times of a day, are recurring events that occur on a plurality of days, are associated with one or more days of the week, are associated with a specific calendar date.

In other features, the method further comprises the steps of determining the occurrence of one of the time-based trigger events for deactivating call forwarding and automatically notifying the cellular provider to deactivate call forwarding to the target phone number.

In another feature, the method further comprises the steps of determining the occurrence of one of the time-based trigger events for deactivating call forwarding and notifying, after receiving authorization from the user, the cellular provider to deactivate call forwarding to the target phone number.

Preferably, the step of notifying is performed automatically by the cellular phone or is performed by the cellular phone after receiving specific authorization from the user. Such specific authorization may be provided by the user in advance or in response to a prompt by the cellular phone.

In yet another feature, the step of notifying includes transmission of call forward service codes of the cellular provider, wherein the user is not required to know the call forward service codes of the cellular provider.

In another feature, the method further comprises providing a call forward status indicator to the user, wherein the step of providing the call forward status indicator comprises displaying the call forward status indicator on the user-interface of the cellular phone and/or generating, by the cellular phone, a beep, series of notes, or spoken words.

In other features, the software installed on the cellular phone is pre-installed prior to the cellular phone being provided to the user. In an alternate embodiment, the software is installed on the cellular phone after the cellular phone has been provided to the user.

The present invention also encompasses computer-readable medium having computer-executable instructions for performing methods of the present invention, and computer networks and other systems that implement the methods of the present invention.

The above features as well as additional features and aspects of the present invention are disclosed herein and will become apparent from the following description of preferred embodiments of the present invention.

### BRIEF DESCRIPTION OF THE DRAWINGS

Further features and benefits of the present invention will be apparent from a detailed description of preferred embodiments thereof taken in conjunction with the following drawings, wherein similar elements are referred to with similar reference numbers, and wherein:

FIG. 1 is a block diagram representation of a wireless telephone, in accordance with aspects of the present invention;

FIG. 2 is a block diagram representation of the user-configurable call forward profile data structure, in accordance with aspects of the present invention;

FIG. 3 is a block diagram representation of the user-configurable Call Forward Application settings data structure, in accordance with aspects of the present invention;

FIG. 4 is a flow chart representation of steps taken by the wireless telephone when a user edits a call forward profile in accordance with an aspect of the present invention;

FIG. 5 is a flow chart representation of steps taken by the wireless telephone when a user edits the Call Forward Application settings in accordance with an aspect of the present invention;

FIG. 6 is a flow chart representation of steps taken by the wireless telephone during the manual forward activation step in accordance with an aspect of the present invention;

FIG. 7 is a flow chart representation of steps taken by the wireless telephone during the manual forward deactivation step in accordance with an aspect of the present invention;

FIG. 8 is a flow chart representation of steps taken by the wireless telephone to enable call forwarding utilizing the cellular provider's service activation procedures in accordance with an aspect of the present invention;

FIG. 9 is a flow chart representation of steps taken by the wireless telephone to disable call forwarding utilizing the cellular provider's service deactivation procedures in accordance with an aspect of the present invention;

FIG. 10 is a flow chart representation of steps taken by the wireless telephone to schedule future trigger events for both time-based and location-based activation in accordance with an aspect of the present invention;

FIG. 11 is a flow chart representation of steps taken by the wireless telephone processing the trigger events to implement both time-based and location-based automatic call forwarding in accordance with an aspect of the present invention;

FIG. 12 is a flow chart representation of steps taken by the wireless telephone processing the trigger events for a currently-activated profile to implement both time-based and location-based automatic call forwarding in accordance with an aspect of the present invention; and

FIG. 13 is a flow chart representation of steps taken by the wireless telephone to determine if the current date and time falls within the defined time window for a given Profile in accordance with an aspect of the present invention.

### DETAILED DESCRIPTION OF PREFERRED EMBODIMENTS

Referring now in greater detail to the drawings in which like numerals represent like components throughout the several views. The specific data structures and the detail fields within these data structures described in this specification are meant to be representative of the types of data structures that would be required to implement the call forwarding automation feature and are not meant to be the definitive or exclusive data structure definitions for implementing the call forwarding automation feature. Likewise, the specific processing sequences and menu selection sequences described in this specification are meant to be representative of the processing and menu selection that would be required to perform the desired operations and are not meant to be the definitive or exclusive processing sequences and menu selection sequences for performing the desired operations.

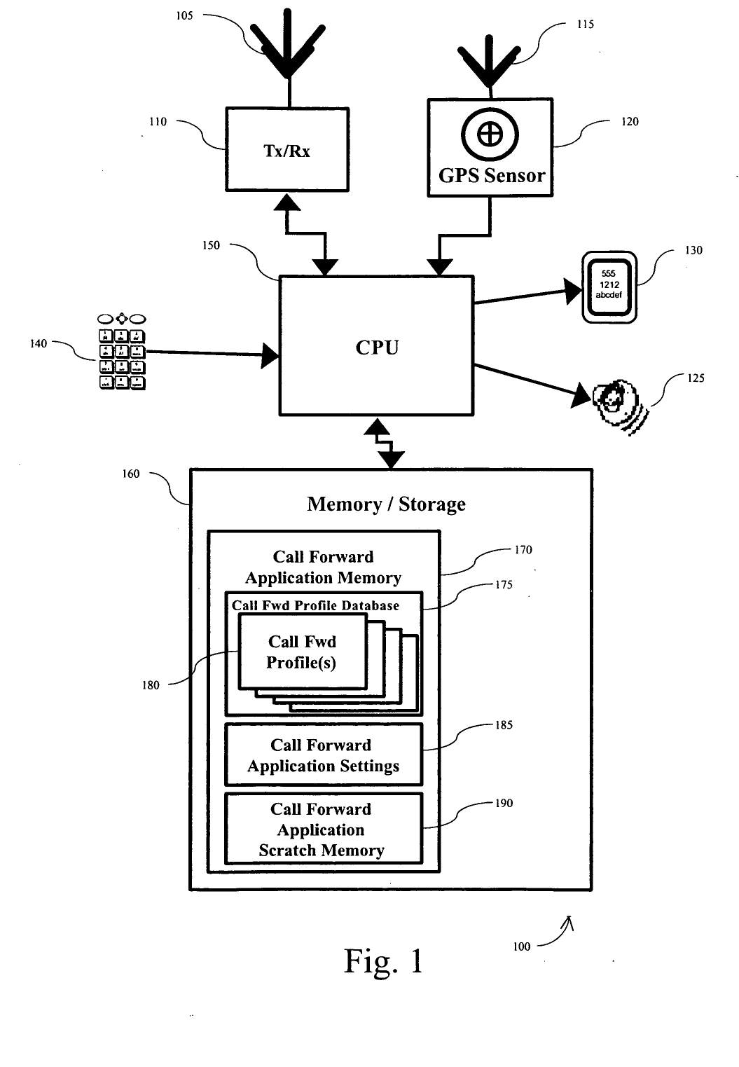

FIG. 1 shows a block diagram of a wireless telephone 100 in accordance with various aspects of the present invention. The wireless telephone 100 is illustrative of a variety of conventional wireless telephones, including analog, dual-mode cellular, tri-mode cellular, digital, and PCS telephones. In conventional manner, radio signals are transmitted and received through an antenna 105 and filtered and mixed to and from lower frequencies in a radio frequency transmit/receive (RF TX/RX) circuit 110, to enable voice communications. This same mechanism also provides data communications, which may include location information obtained from the cellular communication system and/or nearest cellular base station. A GPS Sensor antenna 115 receives signals from GPS satellites; these signals are then filtered and analyzed by the GPS-Sensor unit 120 to obtain a fix on the current location of the GPS-Sensor unit 120, which is capable of transmitting that information to a central processing unit (CPU) 150. This GPS Sensor unit 120 is preferably built into the wireless telephone 100, or alternatively it may be external and connected to the wireless telephone 100 via a wired (e.g. USB or Serial) communications channel or a wireless (e.g. Bluetooth) communications channel. The CPU 150 is connected to memory 160. All or at least a portion of this memory 160 is non-volatile and, therefore, retains values between power cycles. The memory 160 provides storage space for the Call Forward Application Memory 170, which includes the storage of a plurality of user defined Call Fwd Profiles 180 in a Call Fwd Profile Database 175. Call Forward Application Memory 170 also provides storage for the Call Forward Application Settings 185 and Call Forward Application Scratch Memory 190.

A keypad 140 and a display 130 provide conventional user input and output. The keypad 140 is preferably a traditional keypad device with individual alphanumeric keys, but may alternatively be in the form of a soft keypad represented on a touch sensitive panel device. The keypad 140 preferably includes additional function keys, such as scrolling buttons that allow the user to scroll through menu systems.

The display 130 is adapted to provide the ability to display a dialog box for notification of call forwarding status and other user output functions, and preferably has specific addressable areas for graphical indication of call forwarding status, such as a background/wallpaper area and/or an annunciator window with graphic images. The display 130 is a single display unit or multiple discrete display units.

A speaker 125 is used for an audible reminder of current call forwarding status and changes to call forwarding status. The speaker is minimally adapted to provide at least a “beep” type of sound, and is preferably capable of playing digital (e.g. .MIDI or .WAV or .MP3) sound files. The Call Forward Application is either built into the wireless telephone 100 by the wireless telephone manufacturer during the manufacturing process or independently downloaded and installed onto the wireless telephone 100 by the consumer or user.

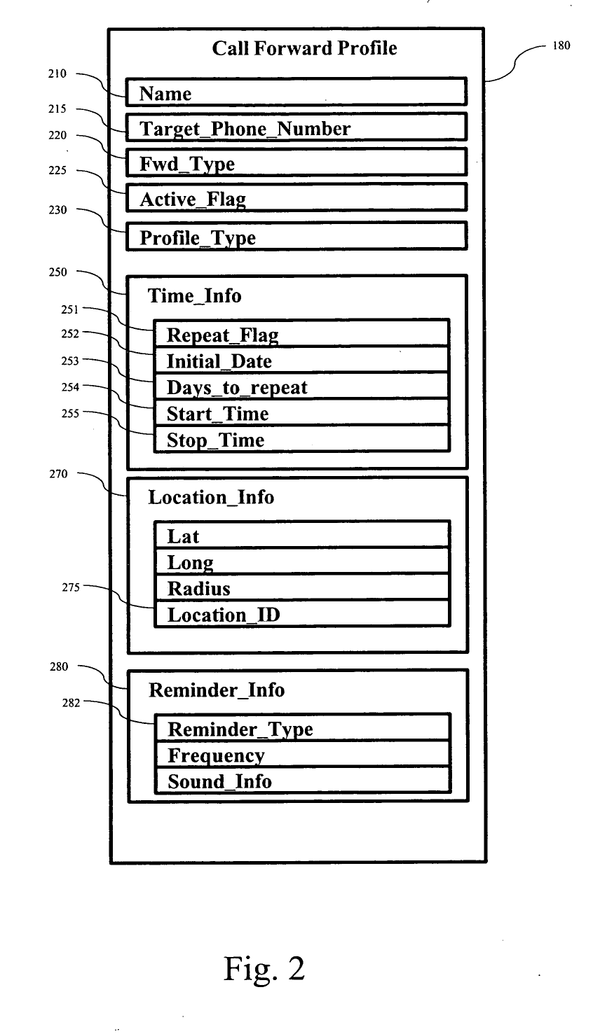

Referring now to FIG. 2, a block diagram representation of the Call Fwd Profile 180 data structure, in accordance with an aspect of the present invention, is illustrated. The Name field 210 is an alphanumeric field that the user provides as a descriptive name for the profile, such as “Home” or “Office_WeekDay”. The Target_Phone_Number field 215 contains the phone number to which calls are forwarded when this Profile is used. The Fwd_Type field 220 contains a list of possible call forward features available from the cellular provider, such as FWD_ALL, FWD_NOANSWER, and FWD_BUSY. The Active_Flag field 225 contains possible values of ACTIVE and PASSIVE—to indicate to the Call Forward Application whether or not actively to monitor this Profile's Time_Info field 250 and Location_Info field 270, which automatically enables or disables call forwarding. Specifically, the Time_Info field 250 contains information related to the day and time during which this Profile is activated. The Repeat_Flag field 251 contains possible values of TODAY_ONLY, DAILY, WEEKDAYS, M-W-F, T-TH, WEEKENDS, SELECT_DAYS, and the like, to specify the days on which the Profile is valid. For example, if the Repeat_Flag field 251 is set to “TODAY_ONLY,” then the Initial_Date field 252 contains the single date on which this Profile is to be activated. Correspondingly, if the Repeat_Flag field 251 is set to “SELECT_DAYS,” then the Days_to_Repeat field 253 contains a bit mask of the days of the week on which this Profile is activated. The Start_Time field 254 contains the time of day to begin activation of this Profile and the Stop_Time field 255 contains the time of day to end activation of this Profile.

The Profile_Type field 230 contains possible values of TIME or LOCATION. If Profile_Type field 230 is set to TIME, then this Profile's Time_Info field 250 is used exclusively to enable and disable call forwarding automatically. If Profile_Type field 230 is set to LOCATION, then the Profile's Time_Info field 250 is used to begin and end monitoring of the wireless telephone's current location and comparing this current location to the Location_Info field 270 to enable and disable call forwarding automatically. If the cellular provider and the particular mobile phone support GPS style location sensing, then the Location_Info field 270 contains a latitude, longitude, and radius describing a circle within which this Profile is activated. If the cellular provider and the particular mobile phone use cellular base station identifier as the location sensing mechanism, then the Location_ID field 275 contains a system-specific identifier to describe the geographic location within which this Profile is activated.

Still referring to FIG. 2, the Reminder_Info field 280 contains information used by the Call Forward Application to specify the visual and audible reminders of the call forwarding state whenever this profile is actively forwarding calls. The Reminder_Type field 282 contains possible values specifying the “type” of reminder, such as, for example, Audible_Only, Dialog_Box, Annuciator_Icon, or Wallpaper_icon.

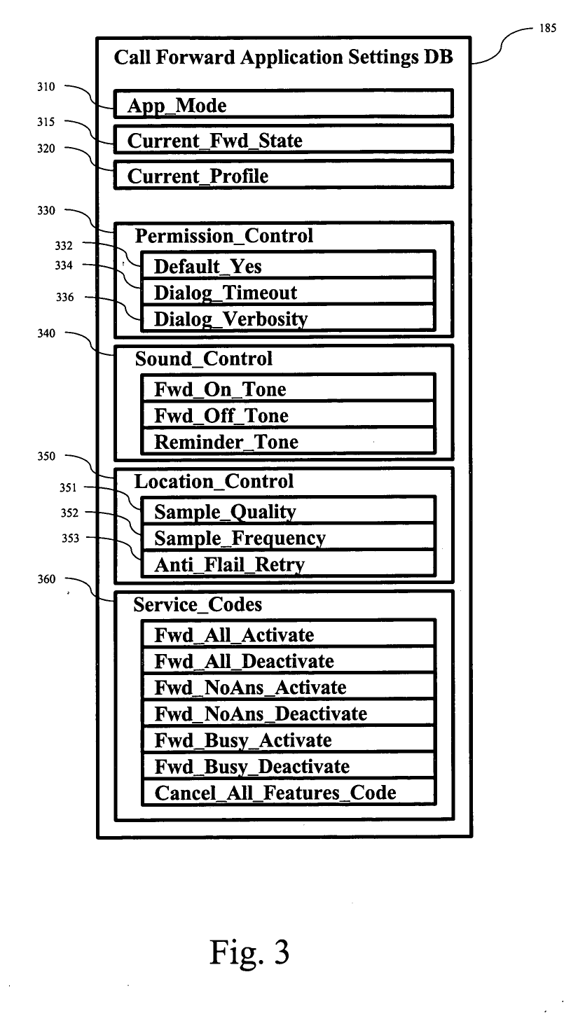

Referring now to FIG. 3, a block diagram representation of the Call Forward Application Settings 185 (Settings) data structure, in accordance with another aspect of the present invention, is illustrated. The App_Mode field 310 contains possible values of MANUAL and AUTOMATIC to control the Call Forward Application behavior. If App_Mode field 310 is set to MANUAL, then the user must utilize the menu selections (Forward_Now and STOP_Forward) provided by the Call Forward Application to forward and un-forward the phone manually. All Call Fwd Profiles 180 (FIG. 2) that are marked as ACTIVE are ignored in MANUAL mode. If App_Mode field 310 contains AUTOMATIC, then the Call Forward Application provides automatic call forwarding and un-forwarding functionality by monitoring all Call Fwd Profiles 180 (FIG. 2) that are marked as ACTIVE.

The Current_Fwd_State field 315 contains a list of possible call forward features available from the cellular provider, such as FWD_ALL, FWD_NOANSWER, and FWD_BUSY, and the additional values of FWD_NONE and FWD_UNKNOWN. This field 315 is set by the Call Forward Application to match the state of call forwarding set by the then currently active Profile. If no Profile has caused call forwarding to be enabled, Current_Fwd_State field 315 is set to FWD_NONE. If an unexpected error occurs while attempting to enable or disable the call forwarding feature with the cellular provider (e.g., the phone call failed in an unexpected way), then Current_Fwd_State field 315 is set to FWD_UNKNOWN to allow the Call Forward Application gracefully to disable call forwarding before attempting any further call forward feature changes.

The Current_Profile field 320 contains a pointer to, or index of, the current Call Fwd Profile 180 (FIG. 2) that has enabled call forwarding.

The Permission Control field 330 contains specific fields to allow the user to control the level of automation and verbosity of the Call Forward Application. For example, the Default_Timeout field 334 allows the user to specify the timeout value for any control dialog that is used by the Call Forward Application to ask the user's permission before automatically enabling or disabling call forwarding. If no user input is received within the window of time defined by the timeout value, then the Call Forward Application uses the Default_Yes field 332 boolean value to interpret this non-answer as a Yes or No permission statement. The Dialog_Verbosity field 336 contains an integer (within a defined range, such as 0-10, 0-50, or 0-100, or the like) to control the verbosity level of the Call Forward application. For example, an integer value of 0 is used to indicate silent operation with no permission dialogs shown and higher integers are used to allow more permission dialogs to be displayed during call forwarding operations. The Sound_Control field 340 allows the user to specify sounds and, optionally, digital sound files (e.g. .WAV, .MIDI, and MP3) to be played through the speaker 125 (FIG. 1) for audible reminders.

The Location_Control field 350 provides the user with control over the Location monitoring functionality to allow the user to tradeoff between maximizing battery life, minimizing network utilization and potential air-time charges, while minimizing delay in sensing location-based call forward state change events. If the phone and cellular provider networks supports multiple levels of position sensing quality, (e.g. 5 meter accuracy, 50 meter accuracy, or 500 meter accuracy), then the Sample_Quality field 351 contains an enumeration to control the level of position sensing to be used by the Call Forwarding Application. The Sample_Frequency field 352 provides control of how often the Call Forward Application samples the phone's geographical position for location-based profiles. The AntiFlail_Retry field 353 contains a counter to control how many location samples must fall inside or outside of the defined geographic region before the phone is deemed to have entered or exited a particular region defined by a location-based profile. Alternatively, the AntiFlail_Retry field 353 is configured to contain a distance inside or outside of the defined region before the phone is deemed to have entered or exited the region. The Service_Codes field 360 contains an array of alphanumeric strings that store the particular feature activation and deactivation codes for each type of call forwarding features available from the cellular provider associated with the particular phone. For example a cellular provider may use “*72” to enable the FWD_ALL feature and “*720” to disable the FWD_ALL feature. Other configurations and alphanumeric strings used by cellular providers for the different types of activation and deactivation codes will be appreciated and understood by those skilled in the art.

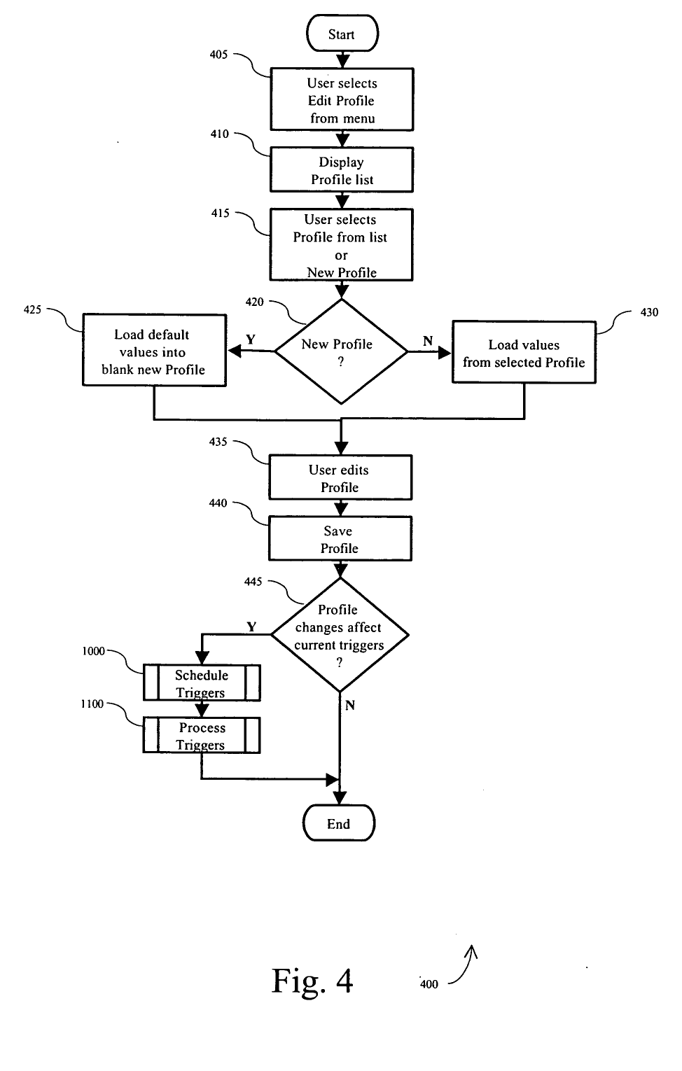

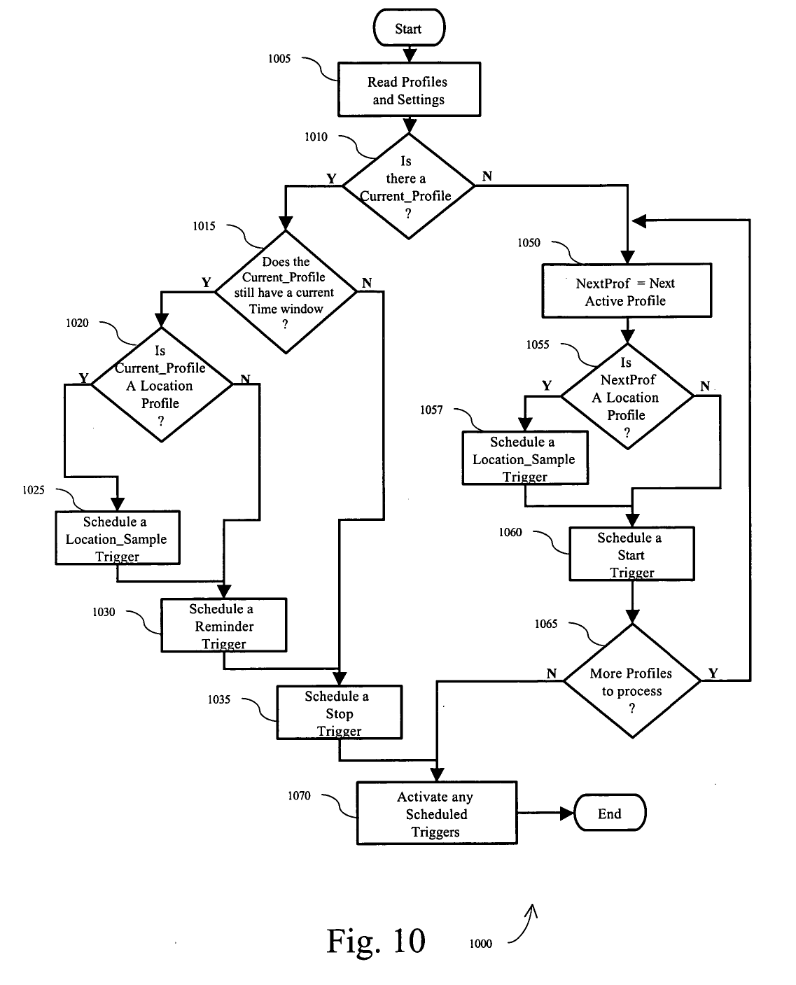

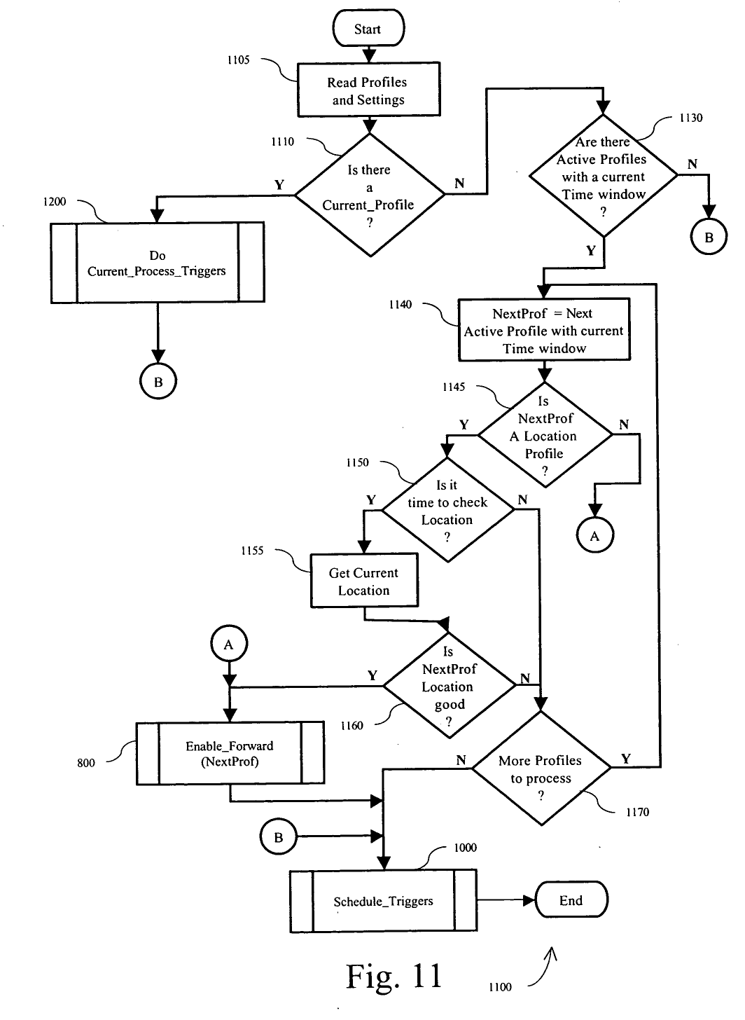

Refer now to FIG. 4, which shows a flow chart representation of steps 400 taken by the wireless telephone 100 (FIG. 1) when a user edits the Call Fwd Profiles 180 (FIG. 2) in accordance with another aspect of the present invention. The Call Forward Application menu system is in an idle state until the user chooses to run the Call Forward Application menu processing functionality. Once in the menu structure, the user navigates through the menu system by pressing the <scroll> keys, <select> keys, and/or other wireless telephone manufacturer specific navigational keys. The user selects the “EDIT PROFILES” menu (step 405) to enter the “EDIT PROFILES” submenu. Once in the “EDIT PROFILES” submenu, a list of stored Profiles is displayed (step 410). The user is able to scroll through a list of Profiles already saved on the telephone or a menu entry “NEW PROFILE” to add a new profile to the telephone, and then select a new or existing Profile for editing (step 415). If the user selects “NEW PROFILE” (at decision 420), then default values are loaded into this new Profile (step 425). If the user selects an existing Profile (at decision 420), then the values currently stored in the Call Fwd Profile Database 175 (FIG. 1) are displayed for editing (step 430). The user then edits the specific fields within the Profile (step 435), and upon completion the changes are saved back to the Call Fwd Profile Database 175 (FIG. 1) (step 440). If the changes to the Profile affect any outstanding trigger event (decision 445), for example if the Profile is ACTIVE and the Time_Info field is changed, then the triggers are rescheduled (step 1000; see FIG. 10), and any newly caused trigger events will be processed (step 1100; see FIG. 11). Otherwise or thereafter, the process 400 ends.

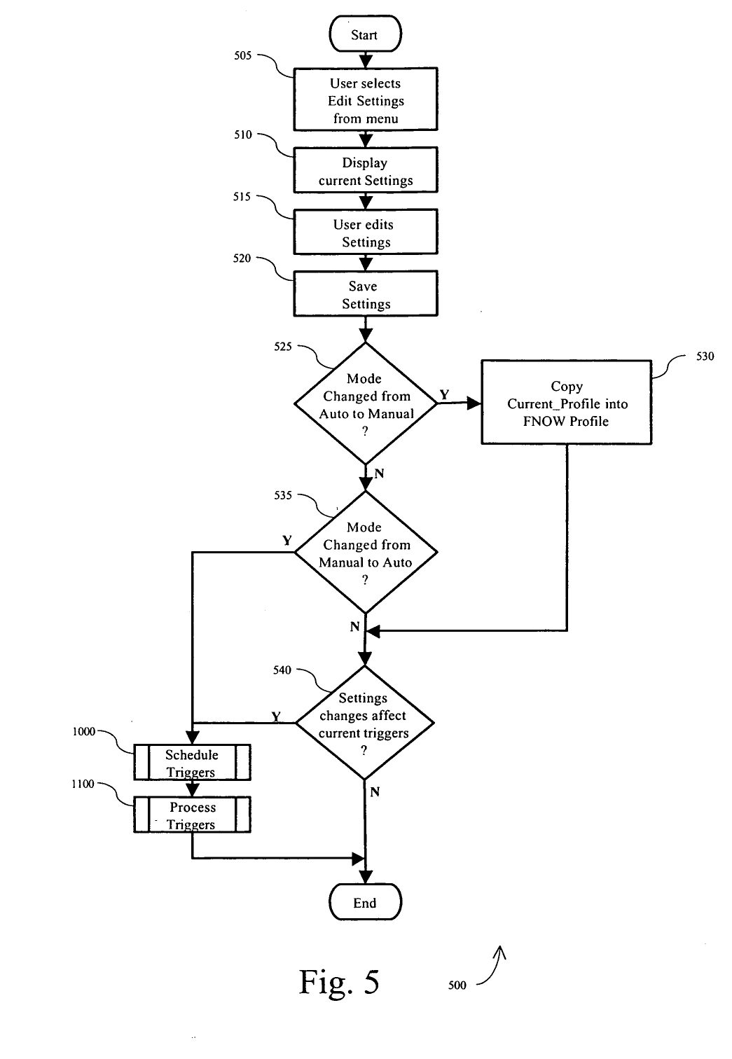

FIG. 5 illustrates the steps 500 taken by the wireless telephone 100 (FIG. 1) when a user edits the Call Forward Application Settings 185 (FIG. 3) in accordance with another aspect of the present invention. First, the user selects the “EDIT SETTINGS” menu (step 505) to enter the “EDIT SETTINGS” submenu. Once in the “EDIT SETTINGS” submenu, the current stored Settings field values are displayed (step 510), and the user then edits the specific fields within the Settings (step 515). Upon completion, the changes are saved back to the Call Forward Application Settings 185 (FIG. 3) (step 520). If the user changed the App_Mode field 310 (FIG. 3) from AUTOMATIC to MANUAL (decision 525), then the current profile that has enabled call forwarding (if any) is used as if it had been manually activated (step 530). If the user changed the App_Mode field 310 (FIG. 3) from MANUAL to AUTOMATIC (decision 535) or if the changes to the Settings affect any outstanding trigger event (decision 540), then the triggers are rescheduled (step 1000; see FIG. 10), and any newly caused trigger events will be processed (step 1100; see FIG. 11). Otherwise or thereafter, the process 500 ends.

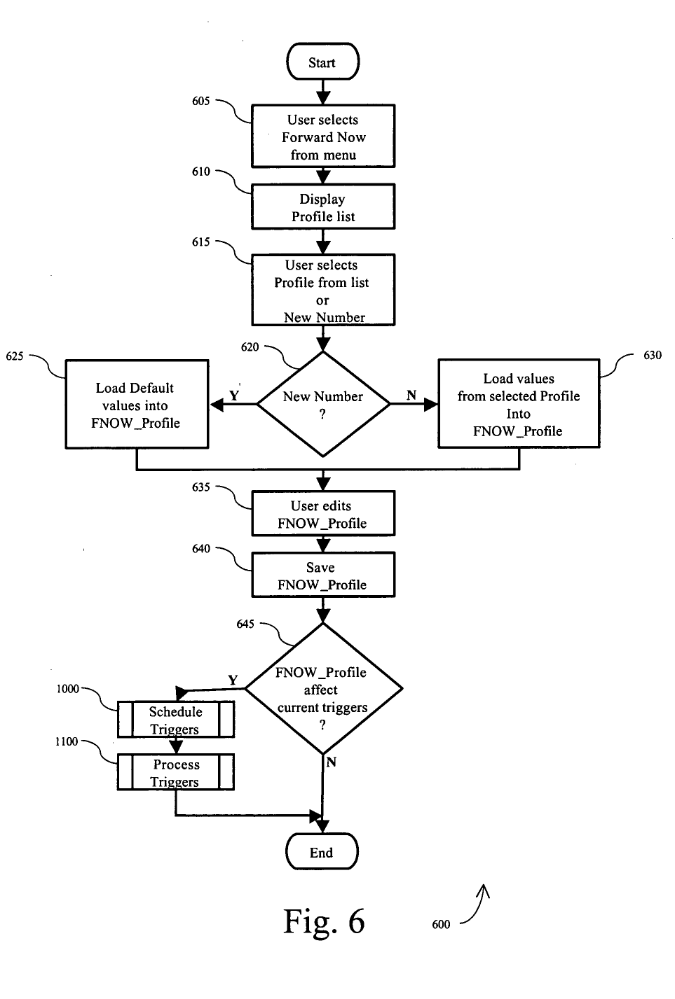

Refer now to FIG. 6, which shows steps 600 taken by the wireless telephone 100 (FIG. 1) when a user selects the manual forward activation step in accordance with another aspect of the present invention. The user first selects the “FORWARD NOW” menu (step 605) to enter the “FORWARD NOW” submenu. Once in the “FORWARD NOW” submenu, a list of stored Profiles is displayed (step 610), and the user is able to scroll through a list of Profiles already saved on the telephone, and a menu entry “NEW NUMBER” to forward to a new target phone number rather than utilize an existing profile. The user then selects a new or existing Profile for editing (step 615). If the user selects “NEW NUMBER” (at decision 620), then default values are loaded into this new FNOW Profile (step 625). If the user selects an existing Profile (at decision 620), then the values currently stored in the Call Fwd Profile Database 175 (FIG. 1) for that Profile are copied into the new FNOW Profile for editing (step 630). The user then edits the specific fields within the FNOW Profile (step 635), and upon completion the new FNOW Profile are saved into the Call Fwd Profile Database 175 (FIG. 1) (step 640). If the changes to the FNOW Profile affect any outstanding trigger event (decision 645), for example if the current time is within the FNOW Profile Time_Info field-defined time window, then the triggers are rescheduled (step 1000; see FIG. 10), and any newly caused trigger events will be processed (step 1100; see FIG. 11). Otherwise or thereafter, the process 600 ends.

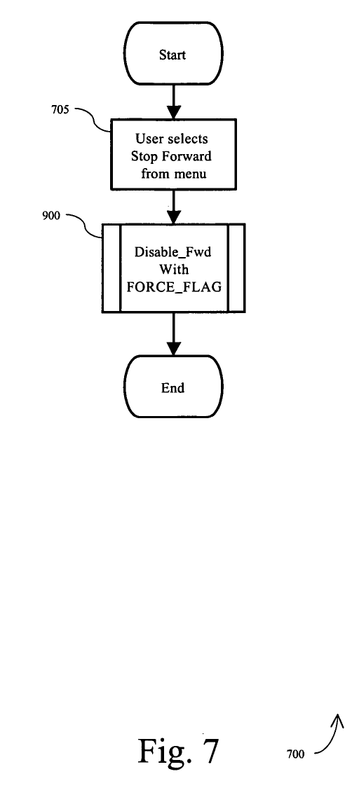

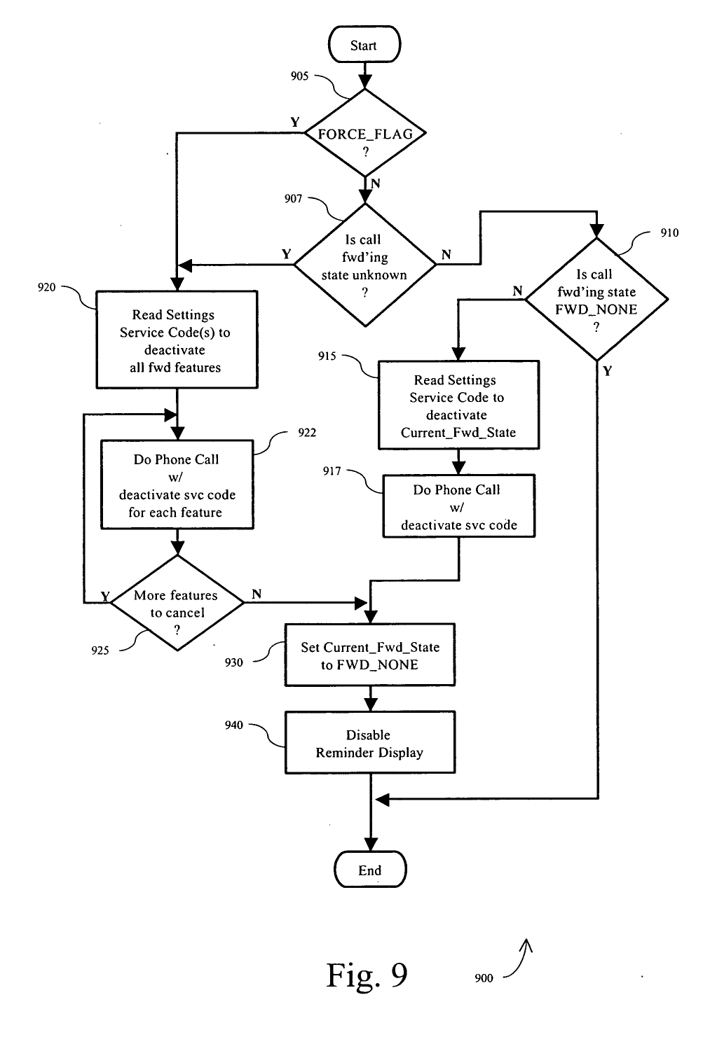

FIG. 7 illustrates steps 700 taken by the wireless telephone 100 (FIG. 1) when a user selects the manual forward deactivation step in accordance with another aspect of the present invention. The user first selects the “STOP FORWARD” menu (step 705) to deactivate any outstanding call forwarding features by invoking the function Disable_Fwd (step 900; see FIG. 9) with a FORCE_FLAG. The Disable_Fwd function is more fully described in FIG. 9.

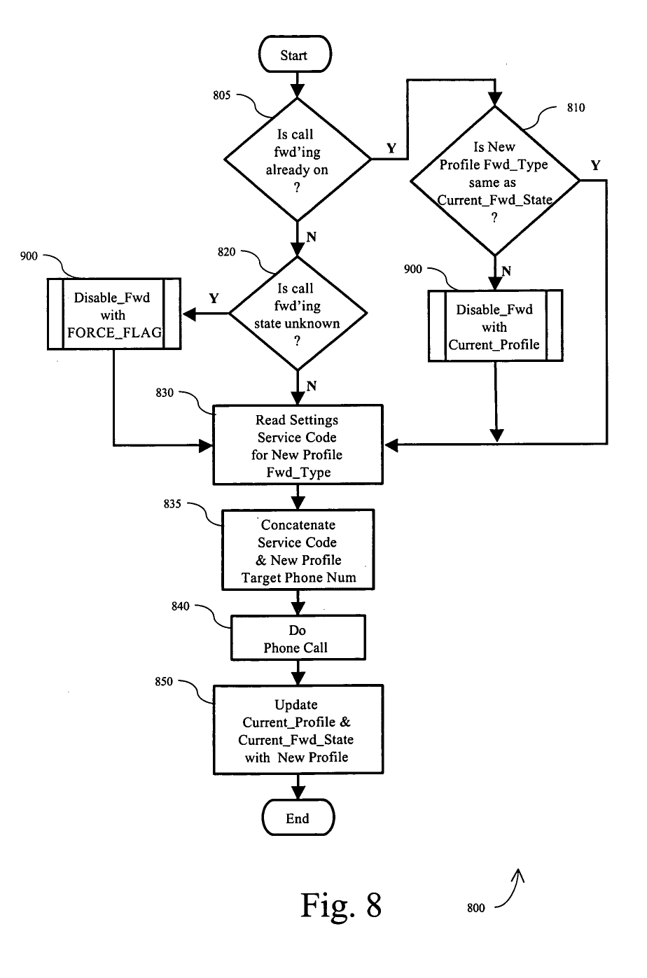

Referring now to FIG. 8, steps 800 taken in the function Enable_Fwd by the wireless telephone 100 (FIG. 1) to enable the cellular provider's call forwarding feature in accordance with another aspect of the present invention are illustrated. If call forwarding is already enabled (at decision 805), the new Active Profile is processed, as follows. If the new Active Profile's Fwd_Type field 220 (FIG. 2) is not the same type of call forwarding as the Current_Fwd_State 315 (FIG. 3) (at decision 810), then the current outstanding call forwarding features are deactivated by invoking the function Disable_Fwd (step 900; see FIG. 9) with the Current_Profile 320 (FIG. 3). If call forwarding is not enabled (at decision 805), and if Current_Fwd_State 315 (FIG. 3) is set to FWD_UNKNOWN (at decision 820), then any outstanding call forwarding features are also deactivated by invoking the function Disable_Fwd (step 900; see FIG. 9) with a FORCE_FLAG.

Still referring to FIG. 8, if the decision at 810 is positive, if the decision at 820 is negative, or after any outstanding call forwarding features are deactivated by invoking the function Disable_Fwd (at step 900), then the appropriate Service_Codes field 360 (FIG. 3) are read based on the new Active Profile's Fwd_Type field 220 (FIG. 2) (step 830). The new Active Profile's Target_Phone_Number 215 (FIG. 2) is concatenated onto the end of this service_code (step 835). The wireless telephone 100 (FIG. 1) then makes the phone call to the cellular provider's network to enable the call forwarding feature. (step 840). The Current_Fwd_State 315 (FIG. 3) and the Current_Profile 320 (FIG. 3) fields are updated to reflect the new Active Profile (step 850). The process 800 then ends.

Refer now to FIG. 9, which shows steps 900 (using the Disable_Fwd function) taken by the wireless telephone 100 (FIG. 1) to disable the cellular provider's call forwarding feature in accordance with another aspect of the present invention. If the FORCE_FLAG has been set (decision 905), or if Current_Fwd_State 315 (FIG. 3) is set to FWD_UNKNOWN (decision 907), then the appropriate values from the Service_Codes field 360 (FIG. 3) are read to deactivate all of the cellular providers' call forwarding features (step 920). Next a phone call is made to the cellular provider's network to disable each call forwarding feature (step 922). If there are multiple features to deactivate, and if there is not a single deactivation service code which disables all call forwarding features (decision 925), then multiple phone calls will be made (i.e., step 922 is repeated). Otherwise, or if there are no more features to deactivate, the Current_Fwd_State 315 (FIG. 3) is set to FWD_NONE (step 930), any Call Forwarding state visual Reminder currently displayed is cancelled (step 940), and the process 900 ends.

Still referring to FIG. 9, if the FORCE_FLAG is not set (decision 905), and if Current_Fwd_State 315 (FIG. 3) is known (decision 907) and specifically set to FWD_NONE (decision 910), then no further processing is required by process 900. Otherwise, if the Current_Fwd_State 315 (FIG. 3) is not set to FWD_NONE (decision 910), then the appropriate Service_Codes field 360 (FIG. 3) deactivation codes are read based on the Current_Profile's Fwd_Type field 220 (FIG. 2) (step 915), and a phone call is made to the cellular provider's network to deactivate the current call forwarding feature (step 917). Next, the Current_Fwd_State 315 (FIG. 3) is set to FWD_NONE (step 930), any Call Forwarding state visual Reminder currently displayed is cancelled (step 940), and the process 900 ends.;

FIG. 10 illustrates process 1000 (according to the Schedule_Triggers function) taken by the wireless telephone 100 (FIG. 1) to schedule Trigger events for both time-based and location-based activation in accordance with another aspect of the present invention. First, the Call Forward Application Settings 185 (FIG. 3) (Settings) and the Call Fwd Profile Database 175 (FIG. 1) are read and utilized (step 1005). If there is a current Profile (decision 1010), then it will be processed for setting of Trigger events. If the current time is still within the Current Profile Time_Info defined time window (decision 1015) and if the Current Profile's Profile_Type field 230 (FIG. 2) is set to LOCATION (decision 1020), then a Location_Sample Trigger event is scheduled (step 1025) based on the Settings' Location_Control values. A Reminder Trigger event and a Stop Trigger event (to cause it to release control of the call forwarding mechanism) are then scheduled for the Current Profile (steps 1030 and 1035). If the Current Profile's Profile_Type field 230 (FIG. 2) is not set to LOCATION (decision 1020), then only a Reminder Trigger event and a Stop Trigger event are scheduled for the Current Profile (steps 1030 and 1035). If the current time is not within the Current Profile Time_Info defined time window (at decision 1015), then only a Stop Trigger event is scheduled (step 1035).

Still referring to FIG. 10, if there is not a current Profile (decision 1010), then all Profiles with Active_Flag 225 (FIG. 2) set to ACTIVE will be processed for setting of Start Trigger events and Location_Sample Trigger events (steps 1050, 1057, and 1060) based on determinations made at decision points 1055 and 1065. All Trigger events scheduled in the above steps of process 1000 are then activated (step 1070) to cause the wireless telephone 100 (FIG. 1) to awake the Call Forward Application and allow the Process_Triggers function 1100 (FIG. 11), as described hereinafter, to execute. The process 1000 then ends.

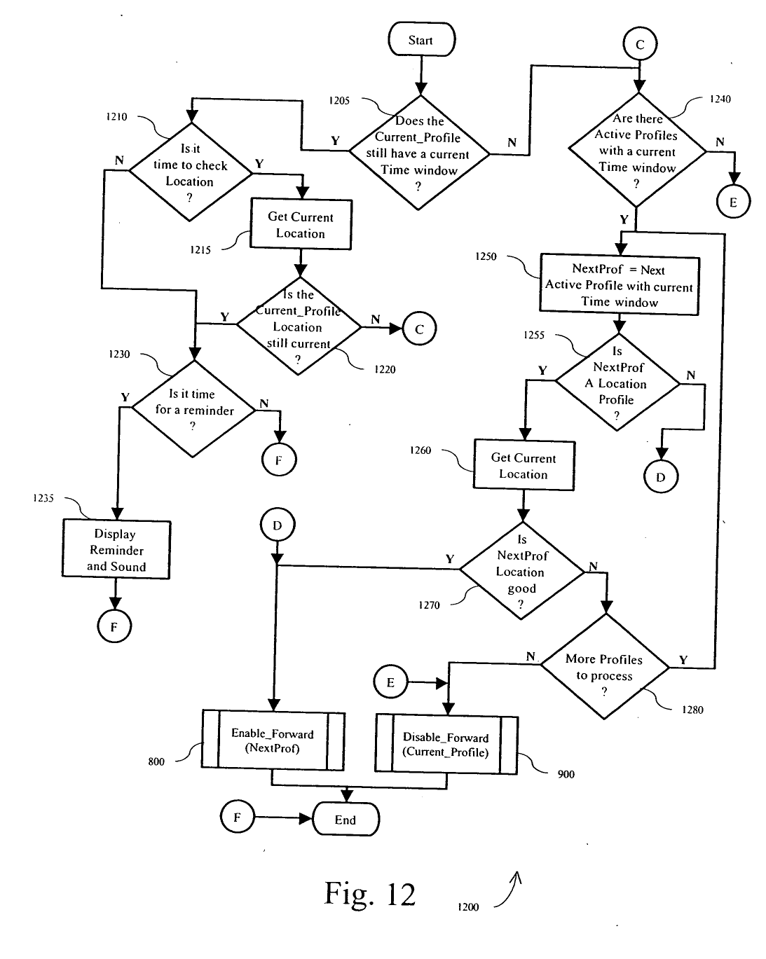

Referring now to FIG. 11, the steps of the Process_Triggers function 1100 performed by the wireless telephone 100 (FIG. 1) to process trigger events for both time-based and location-based activation in accordance with another aspect of the present invention are illustrated. First, the Call Forward Application Settings 185 (FIG. 3) (Settings) and the Call Fwd Profile Database 175 (FIG. 1) are read and used to process trigger events (step 1005). If there is a current Profile (decision 1110), then the current profile is used to process the trigger events, as explained in greater detail by the Current_Process_Triggers process (step 1200; FIG. 12). If there is not a current Profile (decision 1110), then all Active Profiles are processed to determine if call forwarding can be enabled or left disabled (decision 1130). Each Active Profile in the Call Fwd Profile Database 175 (FIG. 1) with the current time within its Time_Info defined window is reviewed (step 1140) for candidacy for taking control of call forwarding. If such a candidate Profile's Profile_Type field 230 (FIG. 2) is set to TIME (decision 1145), then it will take control and all further scanning of the Call Fwd Profile Database 175 (FIG. 1) ceases. If such a candidate Profile's Profile_Type is set to LOCATION (decision 1145), and it is time to check the current location (decision 1150), and the current location (step 1155) is within its Location_Info defined geographic area (decision 1160), then it will take control and all further scanning of the Call Fwd Profile Database 175 (FIG. 1) ceases. If a candidate Profile is available to take control of the call forwarding, then the Enable_Forward function (see FIG. 8) is invoked (step 800) to enable call forwarding to this new candidate Profile's Target_Phone_Number 215 (FIG. 2). If the candidate Profile is unable to take control, and there are more candidate Profiles to process (decision 1170) then the next candidate Profile is similarly processed. After all of the above processing is completed, the function Schedule_Triggers (see FIG. 10) is invoked (step 1000) to re-schedule Trigger events based on the above possible changes in state. The process 1100 then ends.

FIG. 12 illustrates steps 1200 taken by the wireless telephone 100 (FIG. 1) in the Current_Process_Triggers function for a currently activated profile to process trigger events to both time-based and location-based activation in accordance with another aspect of the present invention. This functionality is utilized by (i.e., contained within) the Process_Triggers functionality, which was described in FIG. 11. First, if the current time is still within the Current Profile Time_Info defined time window (decision 1205), then the Trigger events will be processed to see if it is time to verify Location or remind the user of the current call forwarding state. Thus, if the Current Profile's Profile_Type field 230 (FIG. 2) is set to LOCATION and it is time to check the current location (decision 1210), then the current geographic location of the wireless telephone is obtained and compared (step 1215) with the Current Profile's Location_Info 270 (FIG. 2). If the current location is still within the Current Profile's Location_Info defined geographic area (decision 1220), then the Current Profile remains in control and the process jumps to decision 1240. If the decision at 1210 is negative or if the decision at 1220 is positive, then the system determines if it is time for a reminder for the Current Profile (decision 1230), based on the Current_Profile's Reminder_Info field 280 (FIG. 2). If so, then an audible reminder and visual reminder are provided to the phone user (e.g., through the speaker 125 (FIG. 1) and on the screen 130 (FIG. 1)) (step 1235).

Still referring to FIG. 12, if the Current Profile is releasing control because of an expiration of its Time_Info defined window (decision 1205) or upon an exit from its Location_Info defined geographic area (decision 1220), then all Active Profiles are processed to determine if call forwarding should be changed to a new target phone number or disabled (decision 1240). Each Active Profile in the Call Fwd Profile Database 175 (FIG. 1) with the current time within its Time_Info defined window is reviewed (step 1250) for candidacy for taking control of call forwarding. If such a candidate Profile's Profile_Type field 230 (FIG. 2) is set to TIME (decision 1255), then such candidate Profile takes control and all further scanning of the Call Fwd Profile Database 175 (FIG. 1) ceases. If such candidate Profile's Profile_Type is set to LOCATION (decision 1255), then the current location is obtained (step 1260) and analyzed to determine whether it is within its Location_Info defined geographic area (decision 1270). If so, then such candidate Profile takes control and all further scanning of the Call Fwd Profile Database 175 (FIG. 1) ceases. If a candidate Profile is available to take control of the call forwarding, then the Enable_Forward function (discussed in association with FIG. 8) is invoked (step 800) to enable call forwarding to this new candidate Profile's Target_Phone_Number 215 (FIG. 2). If there is no candidate Profile able to take control after all active Profiles have been processed (decision 1280), and the current Profile is releasing control, then the Disable_Forward function (discussed in association with FIG. 9) is invoked (step 900) to disable call forwarding. The process 1200 then ends.

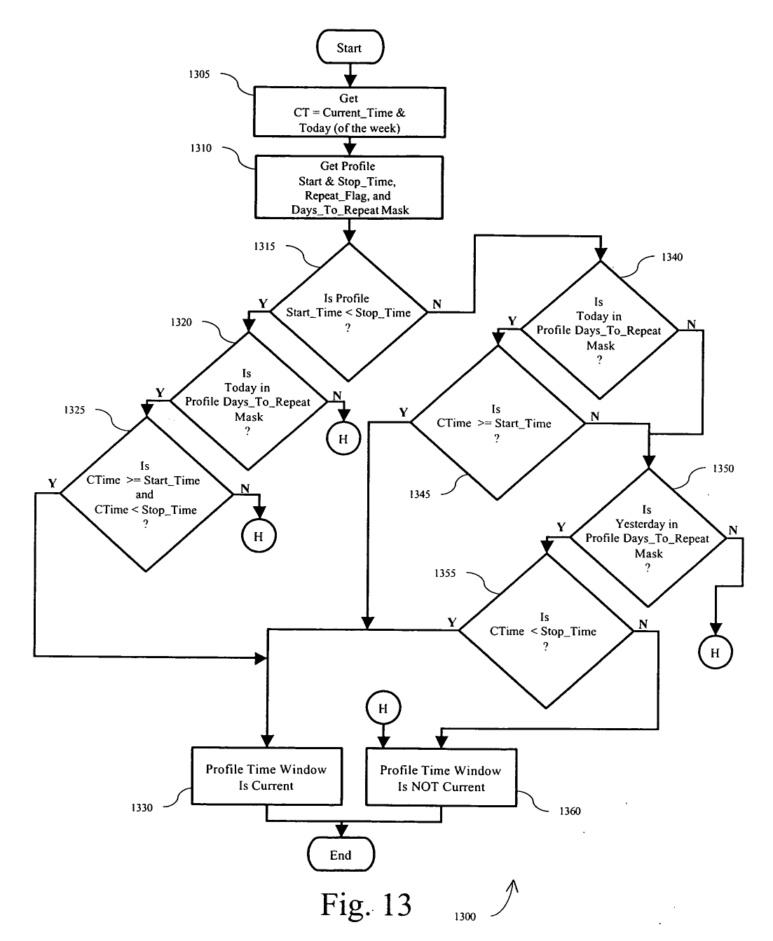

Refer now to FIG. 13, which shows steps 1300 taken by the wireless telephone 100 (FIG. 1) by the Current_Time_Window function to determine if the current date and time falls within the defined time window for a given Call Fwd Profile 180 (FIG. 2) in accordance with another aspect of the present invention. First, the Current Date and Time are obtained (step 1305). The Profile's Start_Time 255, Stop_Time 254, Repeat_Flags 251, and Days_To_Repeat 253 fields (see FIG. 2) are then obtained (step 1310). If the Start_Time is before the Stop_Time (decision 1315), then the time window does not wrap around midnight (e.g., Start_Time=10:00am and Stop_Time=7:00pm). In such non-midnight-wrapping cases, if the current day is in the Profile's Days_To_Repeat mask (decision 1320) and the current time between the Start_Time and the Stop_Time (decision 1325), then the Profile's time window is determined to be “current” (step 1330).

If the Start_Time is after the Stop_Time (decision 1315), then the time window wraps around midnight (e.g., Start_Time=5:00pm and Stop_Time =8:00am). In this midnight-wrapping case, if the current day is in the Profile's Days_To_Repeat mask (decision 1340) and the current time is after the Start_Time (decision 1345), then again the Profile's time window is determined to be “current” (step 1330). Otherwise, if the previous day (i.e., “yesterday”) is in the Profile's Days_To_Repeat mask (decision 1350) and the current time prior to the Stop_Time (decision 1355), then again the Profile's time window is determined to be “current” (step 1330). In all other cases, the Profile's time window is determined to be “not current” (step 1360). The process 1300 then ends.

In summary, according to various aspects of the present invention, programming is provided that enables the user of a cellular telephone manually to activate and deactivate call forwarding utilizing a user-defined profile. Programming is also provided that enables the user to add and configure new profiles, change parameters in existing profiles, and to configure and enable the call forwarding automation feature control settings. Programming is also provided for providing the user with audible and/or visual reminders of the current call forwarding state. In another embodiment, the wireless telephone automatically prompts the user for activation or deactivation of call forwarding upon each trigger event. In this embodiment, the trigger event is used only to provide a suggested change to the call forwarding state, rather than automatically activating or deactivating call forwarding without user input. If user input is not received during a defined period in response to the prompt, the wireless telephone automatically activates or deactivates call forwarding only if a call forwarding automation feature control setting time-out default option is enabled.

In view of the foregoing detailed description of preferred embodiments of the present invention, it readily will be understood by those persons skilled in the art that the present invention is susceptible to broad utility and application. While various aspects have been described in the context of screen shots, displays, and flow charts, it should be understood that additional aspects, features, and methodologies of the present invention will be readily discemable therefrom. Many embodiments and adaptations of the present invention other than those herein described, as well as many variations, modifications, and equivalent arrangements and methodologies, will be apparent from or reasonably suggested by the present invention and the foregoing description thereof, without departing from the substance or scope of the present invention. Furthermore, any sequence(s) and/or temporal order of steps of various processes described and claimed herein are those considered to be the best mode contemplated for carrying out the present invention. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in various different sequences and orders, while still falling within the scope of the present inventions. In addition, some steps may be carried out simultaneously. Accordingly, while the present invention has been described herein in detail in relation to preferred embodiments, it is to be understood that this disclosure is only, illustrative and exemplary of the present invention and is made merely for purposes of providing a full and enabling disclosure of the invention. The foregoing disclosure is not intended nor is to be construed to limit the present invention or otherwise to exclude any such other embodiments, adaptations, variations, modifications and equivalent arrangements, the present invention being limited only by the claims appended hereto and the equivalents thereof.

1. A method of forwarding calls directed to a cellular phone to a target phone number, comprising the steps of:
(i) defining a call forward profile associated with the cellular phone, the call forward profile defining a window of time for forwarding calls directed to the cellular phone, the call forward profile further identifying the target phone number associated therewith;
(ii) storing the call forward profile in memory in the cellular phone;
(iii) determining, by the cellular phone, that the cellular phone is currently within the window of time of the call forward profile; and
(iv) notifying, by the cellular phone, a cellular provider associated with cellular phone to forward later-received calls to the target number.

2. The method of claim 1 further comprising the step of notifying the cellular provider to deactivate call forwarding to the target phone number after expiration of the window of time.

3. The method of claim 2 wherein the cellular phone provides the cellular provider with the expiration of the window of time during the step of notifying the cellular provider to forward later-received calls.

4. The method of claim 2 wherein, upon the expiration of the window of time, the cellular phone notifies the cellular provider to deactivate call forwarding to the target number.

5. The method of claim 2 further comprising the step of automatically notifying the cellular provider to forward calls directed to the cellular phone to a second target phone number after expiration of the window of time.

6. The method of claim 1 wherein the cellular phone is associated with a user and wherein the user is not required to know call forward service codes of the cellular provider.

7. The method of claim 1 wherein the step of notifying is performed automatically by the cellular phone without further input by a user of the cellular phone.

8. The method of claim 1 wherein the step of notifying is performed by the cellular phone after specific authorization is received from a user of the cellular phone.

9. The method of claim 1 wherein the cellular phone provides a user-interface for the user to define the call forward profile.

10. The method of claim 1 wherein the cellular phone provides a call forward status indicator to a user of the cellular phone.

11. The method of claim 10 wherein the call forward status indicator is displayed on a screen of the cellular phone.

12. The method of claim 10 wherein the call forward status indicator is a sound generated by the cellular phone, wherein the sound includes a beep, series of notes, or spoken words.

13. The method of claim 10 wherein the call forward status indicator is generated upon the forwarding of each call to the target phone number.

14. The method of claim 10 wherein the call forward status indicator is generated after notifying the cellular provider to forward calls to the target number.

15. The method of claim 10 wherein the call forward status indicator is generated on a periodic basis.

16. A method of programming a cellular telephone to forward calls to a target phone number, the cellular telephone being associated with a cellular provider, comprising:
(i) defining a time-based trigger event for call forwarding purposes;
(ii) associating the target phone number with the trigger event;
(iii) storing the trigger event and the target phone number in memory in the cellular telephone;
(iv) detecting, by the cellular telephone, the occurrence of the trigger event; and
(v) upon detection of the trigger event, notifying by the cellular telephone the cellular provider to forward later-received calls to the target number.

17. The method of claim 16 wherein the trigger event is a specific time of day, is a recurring event, is based on a day of the week, or is a specific calendar day.

18. The method of claim 16 wherein the trigger event has an expiration and further comprising the step of notifying the cellular provider to deactivate call forwarding to the target phone number upon the expiration.

19. The method of claim 16 wherein the trigger event has an expiration and further comprising the step of automatically notifying the cellular provider to forward calls directed to the cell phone number to a second target phone number after the expiration.

20. The method of claim 16 wherein the cellular phone is associated with a user and wherein the user is not required to know call forward service codes of the cellular provider.

21. The method of claim 16 wherein the step of notifying is performed automatically by the cellular phone without further input by a user of the cellular phone.

22. The method of claim 16 wherein the step of notifying is performed by the cellular phone after prompting a user of the cellular phone and receiving authorization from the user.

23. The method of claim 16 wherein the trigger event and the associated target phone number are part of a user-defined profile stored in memory in the cellular phone.

24. The method of claim 16 wherein the cellular phone provides a call forward status indicator to a user of the cellular phone.

25. The method of claim 24 wherein the call forward status indicator is displayed on a screen of the cellular phone.

26. The method of claim 24 wherein the call forward status indicator is a sound generated by the cellular phone, wherein the sound includes a beep, series of notes, or spoken words.

27. The method of claim 24 wherein the call forward status indicator is generated upon the occurrence of the trigger event.

28. The method of claim 24 wherein the call forward status indicator is generated upon the forwarding of each call to the target phone number.

29. A method of enabling activation and deactivation of call forwarding in a cellular phone, the cellular phone associated with a cellular provider, comprising the steps of:
(i) enabling a user of the cellular phone to define a plurality of call forward profiles associated with the cellular phone, each call forward profile defining time-based activation and deactivation trigger events, each call forward profile having associated therewith a respective target phone number for call forwarding purposes;
(ii) storing the plurality of call forward profiles in memory in the cellular phone;
(iii) detecting the occurrence of a respective trigger event associated with one of the plurality of call forward profiles; and
(iv) notifying, by the cellular phone, the cellular provider to activate or deactivate call forwarding to the respective target phone number as a function of the respective trigger event and the respective call forward profile.

30. The method of claim 29 wherein the step of notifying is performed automatically by the cellular phone upon the occurrence of the respective trigger event without further input by the user.

31. The method of claim 29 wherein the step of notifying is performed by the cellular phone after the occurrence of the respective trigger event and after receiving specific authorization from the user of the cellular phone.

32. The method of claim 29 wherein trigger events are associated with specific times of a day, are recurring events that occur on a plurality of days, are associated with one or more days of the week, or are associated with a specific calendar date.

33. The method of claim 29 wherein the user is not required to know call forward service codes of the cellular provider.

34. The method of claim 29 wherein the cellular phone include software installed thereon to enable the user to define the call forward profiles.

35. The method of claim 29 wherein the cellular phone provides a call forward status indicator to the user.

36. The method of claim 35 wherein the call forward status indicator is displayed on a screen of the cellular phone.

37. The method of claim 35 wherein the call forward status indicator is a sound generated by the cellular phone, wherein the sound includes a beep, musical notes, or spoken words.

38. The method of claim 35 wherein the call forward status indicator is generated upon the occurrence of the respective trigger event.

39. The method of claim 35 wherein the call forward status indicator is generated upon the forwarding of each call to the respective target phone number.

40. A cellular phone associated with a cellular provider and having software installed thereon that is configured to perform the steps comprising:
(i) providing a user-interface to a user of the cellular phone to define a call forward profile, the call forward profile defining time-based trigger events for activating and deactivating call forwarding associated with the cellular phone, the call forward profile identifying a target phone number associated therewith;
(ii) storing the call forward profile in memory in the cellular phone;
(iii) thereafter, determining the occurrence of one of the time-based trigger events for activating call forwarding; and
(iv) notifying the cellular provider to forward subsequent calls intended for the cellular phone to the target phone number.

41. The cellular phone of claim 40 wherein the trigger events are specific times of a day, are recurring events, are based on a day of the week, or are specific calendar dates.

42. The cellular phone of claim 40 wherein the software installed thereon is further configured to perform the steps of determining the occurrence of one of the time-based trigger events for deactivating call forwarding and automatically notifying the cellular provider to deactivate call forwarding to the target phone number.

43. The cellular phone of claim 40 wherein the software installed thereon is further configured to perform the steps of determining the occurrence of one of the time-based trigger events for deactivating call forwarding and notifying, after receiving authorization from the user, the cellular provider to deactivate call forwarding to the target phone number.

44. The cellular phone of claim 40 wherein the step of notifying is initiated automatically by the software.

45. The cellular phone of claim 40 wherein the step of notifying is initiated by the software after receiving specific authorization input by the user into the cellular phone.

46. The cellular phone of claim 45 wherein the specific authorization is input by the user in advance.

47. The cellular phone of claim 45 wherein the specific authorization is input by the user in response to a prompt by the cellular phone.

48. The cellular phone of claim 40 wherein the step of notifying includes transmission of call forward service codes of the cellular provider and wherein the user is not required to know the call forward service codes of the cellular provider.

49. The cellular phone of claim 40 wherein the software installed thereon is further configured to perform the step of providing a call forward status indicator to the user.

50. The cellular phone of claim 49 wherein the step of providing the call forward status indicator comprises displaying the call forward status indicator on the user-interface of the cellular phone.

51. The cellular phone of claim 49 wherein the step of providing the call forward status indicator comprises generating, by the cellular phone, a beep, musical notes, or spoken words.

52. The cellular phone of claim 40 wherein the software installed thereon is pre-installed prior to the cellular phone being provided to the user.

53. The cellular phone of claim 40 wherein the software installed thereon is installed on the cellular phone after the cellular phone has been provided to the user.
